(19) United States
(12) Patent Application Publication
(10) Pub. No.: US 2014/0174468 A1
(43) Pub. Date: Jun. 26, 2014

(54) CLEANING DEVICE, CLEANING METHOD, AND METHOD OF MANUFACTURING THE CLEANING DEVICE

(71) Applicants: Jeong-Yong PARK, Seoul (KR); Sang-Kyu PARK, Hwaseong-si (KR); Seok-Ju PARK, Hwaseong-si (KR); Min-Kyu BANG, Hwaseong-si (KR); Un-Myung SHIN, Hwaseong-si (KR)

(72) Inventors: Jeong-Yong PARK, Seoul (KR); Sang-Kyu PARK, Hwaseong-si (KR); Seok-Ju PARK, Hwaseong-si (KR); Min-Kyu BANG, Hwaseong-si (KR); Un-Myung SHIN, Hwaseong-si (KR)

(21) Appl. No.: 14/011,782

(22) Filed: Aug. 28, 2013

(30) Foreign Application Priority Data
Dec. 21, 2012 (KR) 10-2012-0151336

(51) Int. Cl. B08B 7/04

(52) U.S. Cl. CPC B08B 7/04
USPC 134/6; 134/201; 134/113; 29/407.01

(57) ABSTRACT

Provided are a cleaning device that may be applied to a manufacturing equipment without stopping operations of the equipment, a cleaning method, and a method of manufacturing a device. The cleaning device includes: a frame substrate configured to frame the cleaning device; a first functional membrane on a first surface of the frame substrate; and a second functional membrane on a second surface of the frame substrate, which is opposite to the first surface. The cleaning method includes: positioning a cleaning device including a frame substrate and functional membranes formed on opposite surfaces of the frame substrate on a support configured to support a substrate, during a semiconductor manufacturing process or a display manufacturing process on the substrate; maintaining the positioning of the cleaning device on the support for a predetermined time period; and removing the cleaning device from the support.

### CROSS-REFERENCE TO RELATED APPLICATIONS

This application claims the benefit of Korean Patent Application No. 10-2012-0151336, filed on Dec. 21, 2012, in the Korean Intellectual Property Office, the disclosure of which is incorporated herein in its entirety by reference.

### BACKGROUND

Example embodiments of inventive concepts relate to an apparatus and/or a method of manufacturing a semiconductor or a display, and more particularly, to a cleaning device and/or a cleaning method for maintaining and cleaning the apparatus for manufacturing a semiconductor or a display, and/or a method of manufacturing a device including the cleaning method.

When manufacturing semiconductors or displays, materials are formed or deposited on a substrate, such as a semiconductor wafer or a dielectric material, through such processes as a photoresist (PR) application, a chemical vapor deposition (CVD), a physical vapor deposition (PVD), an ion implantation, an oxidation, and a nitridation. Also, a material layer formed on the substrate may be exposed to light and etched to form circuits and devices. The above processes may be generally performed in manufacturing equipment of various types, for example, a processing chamber in which plasma is generated. During the processes, the substrate is supported on a support such as a vacuum chuck or an electrostatic chuck. An electrostatic chuck may be contaminated due to by-products generated during processing of the substrate, and accordingly, the electrostatic chuck may be cleaned using an activated cleaning gas or a cleaning solution. The cleaning process using the cleaning gas or the cleaning solution may cause corrosion on a surface of the electrostatic chuck or undesired stoppage of the processes.

### SUMMARY

Example embodiments of inventive concepts may provide a cleaning device that can be applied to a manufacturing equipment without stopping operations of the manufacturing equipment, a cleaning method, and/or a method of manufacturing a device implementing the cleaning method.

Example embodiments of inventive concepts may provide a cleaning device capable of performing at least one additional function from among contamination control in an apparatus in which the support is disposed, temperature stabilization, composition state maintenance, sampling, degassing, and recovery of hydrophobicity of the support, with the cleaning function of the support, a cleaning method, and a method of manufacturing the cleaning device.

Example embodiments of inventive concepts may provide a cleaning device that may be manufactured simply and variously in a view of processing difficulty or a manufacturing method, and a method of manufacturing the cleaning device.

According to an example embodiment of inventive concepts, there is provided a cleaning device including: a frame substrate configured to frame the cleaning device; a first functional membrane on a first surface of the frame substrate; and a second functional membrane on a second surface of the frame substrate, wherein the second surface is opposite to the first surface.

The first functional membrane and the second functional membrane may be a same material. The first functional membrane and the second functional membrane may be different materials from each other.

The first and second functional membranes may include at least one of an organic material, an inorganic material, and a polymer material. At least one of the frame substrate, the first functional membrane, and the second functional membrane may include a chemical action layer or is physically or chemically treated.

At least one of the first functional membrane and the second functional membrane has a multi-layered structure. A pattern may be formed on a surface of at least one of the first functional membrane and the second functional membrane. The frame substrate may include a plurality of protrusions configured to improve a coupling force to the first functional membrane and the second functional membrane.

According to another example embodiment of inventive concepts, there is provided a cleaning method including: positioning a cleaning device including a frame substrate, a first functional membrane and a second functional membrane, the first functional membrane and the second functional membrane on opposite surfaces of the frame substrate, on a support configured to support a substrate, during a semiconductor manufacturing process or a display manufacturing process on the substrate; maintaining the positioning of the cleaning device on the support for a predetermined time period; and removing the cleaning device from the support.

The first functional membrane and the second functional membrane may be a same material, and after contacting the first functional membrane to the support by a predetermined number of times, the cleaning device may be turned over to contact the second functional membrane to the support, the first functional membrane on a first surface of the frame substrate and the second functional membrane on a second surface of the frame substrate.

The cleaning may be performed without stopping operations of an apparatus performing the semiconductor manufacturing process or the display manufacturing process on the substrate. The cleaning may be performed without changing processing conditions in the apparatus.

The cleaning device may perform a cleaning function to clean the support and also perform at least one additional function selected from the group consisting of contamination control in an apparatus in which the support is disposed, temperature stabilization, composition state maintenance, sampling, degassing, and recovery of hydrophobicity of the support.

According to another example embodiment of inventive concepts, there is provided a method of manufacturing a device, the method including: performing processes with respect to a substrate on a support configured to support the substrate, during a semiconductor manufacturing process or a display manufacturing process; determining whether the support needs to be cleaned; when the support needs to be cleaned, cleaning the support using a cleaning device including a frame substrate, and a first functional membrane and a second functional membrane formed on opposite surfaces of the frame substrate; and positioning a new substrate on the support.

The cleaning of the support may include: positioning the cleaning device on the support; maintaining the positioning of the cleaning device on the support for a predetermined time period; and removing the cleaning device from the support.

When the first functional membrane and the second functional membrane are a same material, after contacting the first functional membrane to the support by a predetermined number of times, the cleaning device may be turned over to contact the second functional membrane to the support, a first surface of the frame substrate and the second functional membrane on a second surface of the frame substrate.

In the determining whether the support needs to be cleaned, the support may be cleaned when at least one of a predetermined number of processing times with respect to the substrate and a predetermined condition in a processing apparatus is satisfied.

According to another example embodiment of inventive concepts, there is provided a method of manufacturing a cleaning device, the method including: preparing a frame substrate configuring a frame of the cleaning device; applying a liquid polymer precursor on each of opposite surfaces of the frame substrate using at least one of a coating method, a molding method, an imprinting method, a printing method, and a pulling method; and forming functional membranes on the opposite surfaces of the frame substrate by curing the liquid polymer precursor.

At least one of the frame substrate and the functional membranes formed on the opposite surfaces of the frame substrate including a chemical action layer, or may be physically or chemically treated.

The predetermined location may be on a chuck table, on which the substrate is placed during testing the substrate.

According to another example embodiment of inventive concepts, a cleaning device may include a substrate; a first functional membrane on a first surface of the substrate, the first functional membrane configured to clean; and a second functional membrane on a second surface of the substrate opposite the first surface, the second functional membrane configured to one of clean, control contamination, stabilize temperature, maintain composition state, sample, remove unnecessary gas and reconstruct hydrophobicity.

The cleaning device may be configured to withstand two or more semiconductor manufacturing processes or display manufacturing processes.

According to another example embodiment of inventive concepts, a method of cleaning includes performing a manufacturing process on a first semiconductor substrate; performing the manufacturing process at least once on a cleaning device, the cleaning device including a first functional membrane configured to clean and including a second functional membrane, opposite the first functional membrane, configured to one of clean, control contamination, stabilize temperature, maintain composition state, sample, remove unnecessary gas and reconstruct hydrophobicity; and performing the manufacturing process on a second semiconductor substrate

### BRIEF DESCRIPTION OF THE DRAWINGS

Example embodiments of inventive concepts will be more clearly understood from the following detailed description taken in conjunction with the accompanying drawings in which:

FIGS. 1A and 1B are plan views each showing a cleaning device according to an example embodiments of inventive concepts;

FIG. 2 is a cross-sectional view of the cleaning device taken along line I-I′ of FIG. 1A;

FIGS. 3 through 6 are cross-sectional views of a cleaning device according to another example embodiments of inventive concepts;

FIGS. 7A through 7D are flowcharts illustrating a cleaning method according to an example embodiments of inventive concepts;

FIG. 8 is a conceptual view of a cleaning method applied to a liquid immersion lithography apparatus, according to an example embodiments of inventive concepts;

FIG. 9 is a flowchart illustrating a cleaning method according to another example embodiments of inventive concepts;

FIG. 10 is a conceptual view of the cleaning method illustrated in FIG. 9 applied to a test apparatus;

FIG. 11 is a flowchart illustrating a method of manufacturing a device implementing the cleaning method according to an example embodiments of inventive concepts;

FIG. 12 is a flowchart illustrating a method of manufacturing a device implementing the cleaning method according to another example embodiments of inventive concepts;

FIG. 13 is a flowchart illustrating a method of manufacturing a device implementing the cleaning method according to another example embodiments of inventive concepts;

FIG. 14 is a conceptual view illustrating a method of manufacturing a cleaning device according to an example embodiments of inventive concepts; and

FIGS. 15 through 19 are conceptual views illustrating a method of manufacturing a cleaning device according to another example embodiment of inventive concepts.

### DETAILED DESCRIPTION OF EXAMPLE EMBODIMENTS

Hereafter, example embodiments will be described more fully with reference to the accompanying drawings, in which some example embodiments are shown.

This invention may, however, be embodied in many different forms and should not be construed as limited to the example embodiments set forth herein. Rather, these example embodiments are provided so that this disclosure will be thorough and complete, and will fully convey the scope of the invention to those of ordinary skill in the art.

It will be understood that when an element or layer is referred to as being “connected to” another element or layer, the element or layer may be directly connected to another element or layer or intervening a third element or layer. Furthermore, when an element is referred to as being “on” another element or layer, the element or layer may be “directly on” or intervening a third element or layer. In the drawings, lengths and sizes of layers and regions may be exaggerated for clarity and elements that are not related to the description are removed. Also, like reference numerals refer to like elements throughout. The terminology used herein is for the purpose of describing particular example embodiments only and is not intended to be limiting of the invention. As used herein, the term “and/or” includes any and all combinations of one or more of the associated listed items. Expressions such as “at least one of,” when preceding a list of elements, modify the entire list of elements and do not modify the individual elements of the list. The term “predetermined” is intended to have a similar meaning as “given” or “desired.”

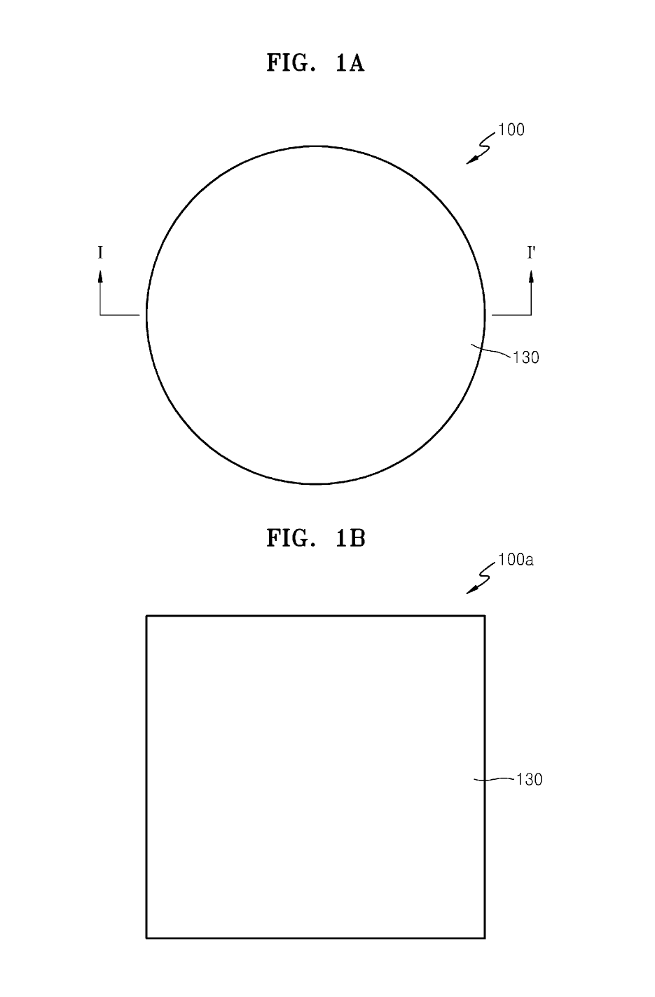

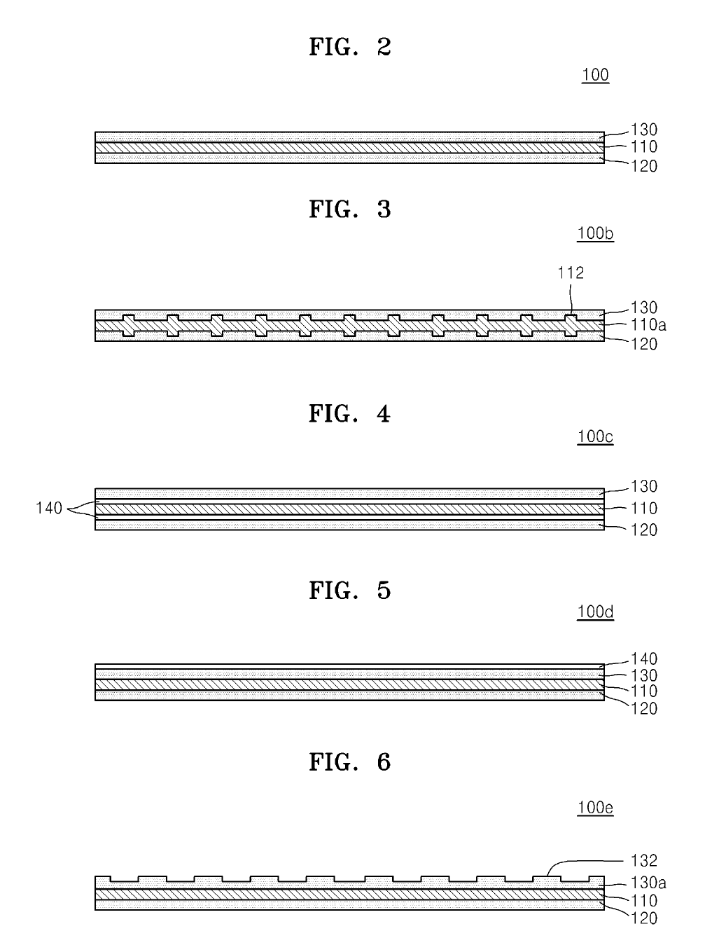

FIGS. 1A and 1B are plan views of cleaning devices 100 and 100a according to example embodiments of inventive concepts, and FIG. 2 is a cross-sectional view of the cleaning device 100 taken along line I-I′ of FIG. 1A. The cleaning device 100a of FIG. 1B may have a cross-sectional structure that is the same as that shown in FIG. 2.

Referring to FIGS. 1A, 1B, and 2, the cleaning device 100 or 100a of the present example embodiment may include a frame substrate 110, a first functional membrane 120, and a second functional membrane 130.

The frame substrate 110 acts as a frame for the cleaning device 100 or 100a, and may be formed of a material that is suitable for supporting the first and second functional membranes 120 and 130 formed on upper and lower surfaces thereof. For example, the frame substrate 110 may include at least one dielectric material and/or semiconductor material among aluminum oxide, quartz, glass, silicon, engineering plastic, and super engineering plastic. Examples of the engineering plastic and the super engineering plastic may include polyimide, polyethylene, polyethylene terephthalate, acetyl cellulose, polycarbonate, polypropylene, and polyamide. The frame substrate 110 may be, for example, a silicon wafer. The frame substrate 110 may include at least one metal material from among aluminum, aluminum alloy, stainless steel, and titanium.

Surfaces of the frame substrate 110 may undergo general surface treatment, for example, a chemical or physical treatment such as a chromic-acid process, an ultraviolet ray (UV) process, an ozone process, a flame surface treatment, a high voltage exposure, and an ionized radioactive treatment, or a coating process using a primer such as an adhesive material, a hexamethyldisilazane (HMDS), or a self-assembly monolayer (SAM) process.

The frame substrate 110 may be formed to have a single-layered structure or a multi-layered structure. A thickness of the frame substrate 110 may be selected appropriately. For example, the frame substrate 110 may have a thickness of 500 μm or less. Alternately, the frame substrate 110 may have a thickness ranging from 1 μm to 300 μm or from 1 μm to 100 μm. However, example embodiments may vary and the thickness of the frame substrate 110 is not limited to the above numerical ranges.

A horizontal cross-section of the frame substrate 110 may be controlled to have various shapes, and accordingly, horizontal cross-sections of the first and second functional membranes 120 and 130 formed on the frame substrate 110 and the entire cleaning device may be determined by the horizontal cross-section of the frame substrate 110. The horizontal cross-section of the frame substrate 110 may correspond to a structure of a support that is to be cleaned or a structure of a substrate supported by the support. For example, the horizontal cross-section of the frame substrate 110 may have a circular or a square structure as shown in FIGS. 1A and 1B. However, example embodiments may vary and the horizontal cross-section of the frame substrate 110 is not limited to the above examples. For example, the horizontal cross-section of the frame substrate 110 may have various shapes, such as a pentagonal shape or an oval shape corresponding to the structure of the support or the substrate.

The first and second functional membranes 120 and 130 may be formed of the same material as or different materials from each other.

If the first and second functional membranes 120 and 130 are formed of the same material, the first and second functional membranes 120 and 130 may have the same purpose as each other, and accordingly, lifespan of the cleaning device 100 may be doubled. For example, if both the first and second functional membranes 120 and 130 are formed as membranes for cleaning the support, one of the first and second functional membranes 120 and 130 is used to clean the support, and then, the other of the first and second functional membranes 120 and 130 is used to clean the support. As an example, the first functional membrane 120 may be used to clean the support and then the second functional membrane 130 may be used to clean the support. Thus, lifespan of the cleaning device may be doubled.

If the first and second functional membranes 120 and 130 are formed of different materials from each other, the first and second functional membranes 120 and 130 may have different purposes from each other. For example, one of the first and second functional membranes 120 and 130 may be used to clean the support, and the other of the first and second functional membranes 120 and 130 may be used to perform an additional function. For example, the additional function may include contamination control in equipment, temperature stabilization, composition maintenance, sampling, degassing, and reconstruction of hydrophobic property of the support. The additional function may be executed by the functional membrane that does not contact the support.

The purpose of contamination control is to reduce the amount of contamination in the equipment to be as small as possible by selectively and/or non-selectively removing contamination materials such as fine dust and fine particles floating in the air or fluid in the equipment. The temperature stabilization and the composition maintenance may be performed to reduce and/or minimize variations in temperature and in the composition state in the equipment by cleaning the support by disposing the cleaning device on the support instead of disposing a substrate on the support, without stopping the operation of the equipment during the process of manufacturing a semiconductor or a display. The functional membrane that does not contact the support may be formed of a material that reduces and/or minimizes the temperature variation and the composition variation in order to perform the above purposes. The sampling is a gathering of gas or fine particles in the equipment via the functional membrane to monitor a status variation in the equipment. The degassing denotes removal of unnecessary gas in the equipment. The hydrophobic property reconstruction is performed to increase the hydrophobic property of the surface of the support so that moisture may not exist on the surface of the support. The hydrophobic property reconstruction may be performed by using the functional membrane that contacts the support.

The first and second functional membranes 120 and 130 may undergo various chemical and/or physical treatments, for example, a chromic-acid process, a UV process, an ozone process, a flame surface treatment, a high voltage exposure, and an ionized radioactive treatment, or a coating process using a primer such as an adhesive material, an HMDS, or a SAM process.

The first and second functional membranes 120 and 130 may include an organic material or an inorganic material, and may include various polymers such as polystyrene (PS) or polydimethylsiloxane (PDMS). A chemical agent such as the HMDS or the SAM may be deposited on the first and second functional membranes 120 and 130 to form a chemical action layer, in order to increase a coupling power or an adhesive force.

Examples of the material forming the first and second functional membranes 120 and 130 are as follows.

A functional membrane may adopt an appropriate material according to a function thereof, and in particular, to a polymer having a property allowing process residue to be easy attached to a surface thereof. For example, the polymer may be a polymer having optimized characteristics such as an optimized elastic module, an optimized integrity, and an optimized surface energy, and accordingly, the polymer may easily hold particles of the process residue on the surface of the support or in the equipment. In particular, the integrity of the polymer may be, for example, less than 2 GPa or less than 1 GPa, and an elastic module of the polymer may be at least 0.98 N/mm². Also, a surface free energy of the polymer may be less than 30 mJ/m². However, example embodiments may vary and the characteristics of the functional membrane are not limited to the above examples.

As a particular example of the material forming the functional membrane, a heat-resistant resin or polymer and an energy-ray curable resin or polymer may be used. In the present example embodiment, the functional membrane may be a heat resistant polymer. By using the heat resistant polymer, a conveying defect or contamination may not occur even when the functional membrane is used in an apparatus used under a high temperature, for example, an ozone asher, an exposure device, a physical vapor deposition (PVD) apparatus, an oxidation/diffusion furnace, an ambient-pressure chemical vapor deposition (APCVD) apparatus, a low pressure CVD (LPCVD) apparatus, and a plasma CVD apparatus.

The heat resistant polymer forming the functional membrane may have an optimized heat resistance. For example, components and characteristics of the heat resistant polymer may be optimized so as to bear a high temperature ranging from 25° C. to 400° C., and especially from 150° C. to 400° C., under a vacuum pressure. The surface of the support may be cleaned while maintaining a high temperature in the chamber, such as a processing temperature during the manufacturing processes. Accordingly, there is no need to adjust the temperature between the processing temperature and the cleaning temperature, and thus, processing stability may be improved.

Examples of the heat resistant polymer forming the functional membrane may include polyimide and fluoric resin. In the present example embodiment, the heat resistant polymer may be polyimide. For example, the functional membrane may include one or more polyimide polymers that are known to be suitable for cleaning the processing residue. The polyimide is a polymer including imide groups (—CONRCO—) in its polymer chain, and R may denote a methyl group (CH₃) or a hydrogen or carbon containing group such as an aromatic ring. The polyimide may include linear polyimide and aromatic heterocyclic polyimide. The polyimide may provide an attaching property that is suitable for removing the processing residue, and shows a superior anti-corrosion property under high temperature and vacuum atmosphere.

The polyimide may be obtained by imidating polyamic acid that is a precursor. The polyamic acid may be obtained by reacting tetracarboxylicacid dianhydride and diamine components with each other in an arbitrary appropriate organic solvent by a substantially equivalent mole ratio.

The tetracarboxylicacid dianhydride may be, for example, 3,3′,4,4′-biphenyltetracarboxylic dianhydride, 2,2′,3,3′-biphenyltetracarboxylic dianhydride, 3,3′,4,4′-benzophenonetetracarboxylic dianhydride, 2,2′,3,3′-benzophenonetetracarboxylic dianhydride, 4,4-oxydiphthalic dianhydride, 2,2-bis[4-(2,3-dicarboxyphenoxy)phenyl]hexafluoropropane dianhydride, 2,2-bis(3,4-dicarboxyphenoxy)hexafluoropropane dianhydride (6 FDA), bis(2,3-dicarboxyphenyl)methane dianhydride, bis(3,4-dicarboxyphenyl)methane dianhydride, bis(2,3-dicarboxyphenyl)sulfone dianhydride, bis(3,4-dicarboxyphenyl)sulfone dianhydride, pyromellitic acid dianhydride, ethylene glycol bistrimellitic acid dianhydride. The above materials may be used individually, or a combination of two or more materials may be used.

The diamine component may be a diamine compound having two or more terminals of amine structure and having a polyether structure (hereinafter, referred to as a PE diamine compound), aliphatic diamine, or aromatic diamine. A polyimide resin having a high heat-resistance, low stress, and low modulus characteristics may be obtained from the PE diamine compound.

The PE diamine compound may adopt an arbitrary compound, provided that the compound has a polyether structure and two or more terminals of the amine structures. For example, terminal diamine having polypropylene glycol structure, terminal diamine having polyethylene glycol, terminal diamine having polytetramethylene glycol structure, and terminal diamine having a plurality of structures from among the above structures. The PE diamine compound may have two or more terminals having amine structure, which are prepared from ethylene oxide, propylene oxide, polytetramethylene glycol, polyamine, or a composition thereof.

The organic solvent in which the tetracarboxylic acid and the diamine react with each other may be, for example, N,N-dimethyelacetamide, N-methyl-2-pyrrolidone, and N,N dimethylformeamide. In order to adjust solubility of raw material, a non-polar solvent (for example, toluene or xylene) may be used together.

The imidating of the polyamic acid may be performed by performing an annealing process under an inert atmosphere (representatively, vacuum or nitrogen atmosphere). A temperature of the annealing process may be 150° C. or higher, for example, ranging from 180° C. to 450° C. At the above temperature, volatile components in the resin may be completely removed. Also, since the process is performed under the inert atmosphere, oxidation or degradation of the resin may be prevented.

A polyimide layer may be formed on the frame substrate 110 in the following manner. The polyimide layer may be induced from a liquid polyimide precursor that is directly applied to the surface of the frame substrate 110 without using a substantial adhesive layer, for example, liquid polyamic acid. The liquid polyimide precursor that is directly applied is cured on the surface of the frame substrate 110 to provide firm adhesive force between the frame substrate 110 and the polyimide layer. The polyimide layer may be formed by applying liquid precursor including one or multi-type polyimide precursors, or may further include another polymer precursor that is added in order to improve characteristics of the polyimide layer. The liquid polyimide precursors are cross-linked through the annealing process so as to form a cured polyimide layer. For example, by heating the liquid polyimide precursor at a temperature of at least about 250° C., the cured polyimide layer is formed. As another annealing method, the polyimide precursor may be exposed to UV rays or a chemical curing agent.

According to another example embodiment of inventive concepts, the polyimide layer may be formed by a spin coating method on the surface of the frame substrate 110. In the spin coating process, the liquid polyimide precursor is provided on the surface of the frame substrate, and the frame substrate may be rotated in order to perform a uniform coating. In another example embodiment, a spraying method may be used. According to the spraying method, the liquid polyimide precursor is directly spray coated on the surface of the frame substrate to form the polyimide layer.

The liquid polyimide precursor that is directly applied may provide a polyimide layer showing superior cleaning results in a high vacuum (about less than 10⁻⁷ barr) processing chamber, while preventing the chamber from being contaminated. As the liquid polyimide precursor is directly applied to the frame substrate and a strong bonding occurs between the frame substrate and the polyimide layer, the polyimide layer may not be isolated from the frame substrate when the cleaning device is removed from the support while firmly compressing the polyimide layer onto the surface of the support to perform the cleaning process. Moreover, by forming the polyimide layer using the liquid polyimide precursor on the frame substrate, a relatively thin polyimide layer may be attained while particles of the processing residue may be easily attached thereto, and thus superior electrostatic inducing performance is provided.

The polymer layer may have a thickness that is sufficient enough to accommodate and hold the processing residue that is compressed to the polymer layer, and may serve as a superior electrostatic inducing element between the cleaning device and the support. The thickness of the polymer layer may be less than 50 μm, such as between 5 μm and 50 μm, or may be less than 30 μm, such as between 15 μm and 20 μm. Example embodiments may vary and the thickness of the polymer layer is not limited to the above examples. For example, the thickness of the polymer layer may be equal to or greater than 50 μm if necessary, as an example, for cleaning a probe of a probe apparatus.

An energy ray curable polymer may be a composition including an adhesive material, an energy ray curable material, and/or an energy ray curing initiator.

An arbitrary adhesive material may be included in the energy ray curable polymer according to a purpose of the polymer. A weight average molecular weight (Mw) of the adhesive material may range from 50 to 100, or from 60 to 90. Also, the adhesive material may include an appropriate additive such as a cross-linking agent, a tackifier, a plasticizer, a filler, and/or an antioxidant.

According to an example embodiment of inventive concepts, a pressure sensitive adhesive polymer may be used as the adhesive material included in the energy ray curable polymer. Examples of the pressure sensitive adhesive polymer may include an acryl-based polymer including an acryl-based monomer such as (meta)acrylic acid and/or (meta)acrylic ester as a main monomer. The acryl-based polymer may be used alone or in combination with other polymers. Also, a rubber-based or an acryl-based material, a vinyl alkyl ether based or a silicon based material, a polyester based or a polyamide based material, a urethane based or a styrene/diene block copolymer based material, or an adhesive having an improved creep characteristic by combining a thermal fusing resin having a fusing point of 200° C. or less may be used as the adhesive material that may be included in the energy ray curable polymer. The above materials may be used solely or in combination with each other.

As the energy ray curable polymer, an appropriate material may be used that may function as a cross-link (intersection) when forming a three-dimensional mesh structure, by reacting with the adhesive material due to the energy ray (in general, light, in particular, UV rays). A representative example of the energy ray curable polymer may include a compound having one or more unsaturated double bonds in molecules (hereinafter, referred to as a polymeric unsaturated compound). The polymeric unsaturated compound is non-volatile, and may have a Mw less than 10,000, or less than 5,000. With such a molecular amount, the adhesive material may form the three-dimensional mesh structure effectively. The energy ray curable polymer may be used in a ratio of 0.1 to 50 parts by weight, with respect to the adhesive material of 100 parts by weight.

The energy ray curing initiator may be an appropriate curing initiator (polymerization initiator) according to the purpose thereof. For example, a thermal polymerization initiator may be used when heat is used as the energy ray, and a photopolymerization initiator may be used when light is used as the energy ray. The energy ray curing initiator may be used in a ratio of 0.1 to 10 parts by weight with respect to the adhesive material of 100 parts by weight.

The material forming the functional membrane according to the example embodiments may include an appropriate additive according to the purpose thereof. Examples of the additive may include a surfactant, a plasticizer, an antioxidant, a conductivity loader, a UV absorbent, and a light stabilizer. By adjusting materials and/or amounts of the used additives, the functional membrane having a desired characteristic according to the purpose may be obtained.

The functional membrane according to the present example embodiment may include a metal layer that may search for and hold the processing residue on a surface thereof. The present example may be advantageous for processing chambers in which a considerably high temperature that may not be suitable for the polymer is maintained, for example, a temperature of 400° C. or greater, or in particular, 450° C. or greater. When forming the metal layers on opposite surfaces of the frame substrate, a possibility of generating bowing and warping of the frame substrate may be reduced.

The metal layer may have a relatively small thickness that is sufficient to hold the processing residue on the surface thereof. For example, a soft metal layer may have a thickness of about 1 to 10 μm. The metal layer may include one or more metal materials. For example, the metal layer may include at least one of aluminum, copper, and indium. Components of the metal layer may be selected in consideration of metal contamination. For example, when the metal layer is used in an aluminum deposition chamber, an aluminum layer may be used as the metal layer, and when the metal layer is used in a copper deposition chamber, a copper layer may be used as the metal layer.

The functional membrane of the present example embodiment may include an adhesive layer. A material forming the adhesive layer may be appropriately selected, for example, the adhesive layer may be formed of a general adhesive such as an acryl based or a rubber based material. An acryl based adhesive mainly containing an acryl based polymer may be used as the adhesive layer. The acryl based polymer may be synthesized by polymerizing a monomer mixture mainly containing (meta)acrylic acid alkyl ester as a main monomer and additionally including other monomers that may be copolymerized, if necessary.

The adhesive layer of the functional membrane according to the present example embodiment may have a thickness of about 1 to 100 μm, in particular, about 5 to 50 μm, and may have an adhesive property of about 0.01 to 10 N/10 mm, in particular, 0.05 to 5 N/10 mm.

The cleaning device of the present example embodiment may include a protective film (not shown) for protecting the functional membranes. The protective film may be isolated in an appropriate stage. The protective film may be, for example, a plastic film formed of polyethylene, polypropylene, polybutene, polybutadiene, polyolefin such as polymethylpentene, polyvinyl chloride, polyethylene terephthalate, polybutylene terephthalate, polyurethane, ethylene-vinyl acetate copolymer, ionomer resin, ethylene-methacrylic acid copolymer, ethylene-methacrylic acid ester copolymer, polystyrene, or polycarbonate, a polyimide, or a fluorine resin film, according to the purpose thereof. The protective film may be peel-treated using a peel agent, if necessary. The peel agent may be, for example, a silicon based agent, a long chain alkyl based agent, a fluorine based agent, a fatty acid amide based agent, or a silica based agent. The protective film may have a thickness of about 1 to 100 μm.

In order to clean the surface of the support sufficiently using the cleaning device, the cleaning device may contact the surface of the support with a predetermined degree of attaching force. The attaching of the cleaning device to the support may be performed by applying a voltage.

An electrode (not shown) may be formed in the cleaning device for applying the voltage. The electrode may include at least one conductive material from among, for example, aluminum, copper, titanium, nickel, chrome, and zirconium. The electrode may be formed by one of well-known deposition methods such as a physical deposition, an electronic deposition, an electric plating method, and a screen printing method.

A voltage applied to the cleaning device 100 for adhering the surface of the cleaning device 100 to the surface of the support may be a direct current (DC) voltage of at least about 200 V, for example, a DC voltage of 500 to 600 V, or a DC voltage of 200 to 1000V. The voltage may include a radio frequency (RF) voltage. The voltage may be applied for a time period, in which the processing residue is sufficiently attached to the surface of the cleaning device 100, for example, 0.5 to 5 minutes, and after that, supplying of the voltage may be stopped.

The cleaning device 100 may be adhered to the support by a vacuum absorption, instead of a voltage application. For example, the support may perform the vacuum absorption, and accordingly, the cleaning device 100 may be pulled to be adhered to the surface of the support. The vacuum absorption of the cleaning device 100 may be maintained for a sufficient time period for cleaning the surface of the support, and after that, the vacuum absorption of the cleaning device 100 may be released.

The removal of processing residue using the cleaning device 100 may be performed repeatedly a plurality of times. Also, the cleaning process using the cleaning device 100 of the present example embodiment may be performed in combination with other cleaning processes such as cleaning processes using an activated cleaning gas or a cleaning solution.

According to the cleaning device 100 of the present example embodiment, excellent performance with respect to the high temperature and the high degree of vacuum absorption may be provided while preventing the contamination or the damage of the surface of the support, and thus, the cleaning function having an improved performance when compared with other cleaning methods may be provided. Also, according to the cleaning device 100 of the present example embodiment, the cleaning process may be performed without stopping the manufacturing equipment, and thus, processing performance with respect to the support such as an electrostatic chuck or a vacuum chuck and an increased component lifespan may be provided.

As a reference, equipment that is a cleaning target may be any kind of equipment that is used in semiconductor manufacturing processes or display manufacturing processes, for example, various manufacturing apparatuses or test apparatuses such as an exposure apparatus for forming circuits, a resist application apparatus, a sputtering apparatus, an ion implantation apparatus, a dry etching apparatus, and a wafer prober, and substrate processing apparatuses used under a high temperature such as an ozone asher, a resist coater, an oxidation/diffusion surface, an APCVD apparatus, a LPCVD apparatus, and a plasma CVD apparatus. The equipment to be cleaned is not limited to the above examples. The substrate may be a semiconductor wafer (for example, a silicon wafer), a substrate for a flat panel display such as a plasma display panel (PDP), a liquid crystal display (LCD), a light emitting diode (LED) display, an organic light emitting display (OLED), a compact disc, and a magnetoresistive (MR) head. The substrate is not limited to the above examples. Also, the support may be any kind of support that supports a substrate during the semiconductor manufacturing processes or the display manufacturing processes, for example, an electrostatic chuck, a vacuum chuck, or a prober chuck.

FIGS. 3 through 6 are cross-sectional views of respective cleaning devices 100b through 100e having different structures than that of the cleaning device 100 shown in FIG. 2. For convenience of description, descriptions about the components that are the same as those of FIGS. 1A through 2 are not provided here.

Referring to FIG. 3, a cleaning device 100b of the present example embodiment may have a frame substrate 110a having a structure that is different from that of the frame substrate 110 in the cleaning device 100 of FIG. 2. For example, the frame substrate 110a of the cleaning device 100b may include a plurality of protrusions 112. Such protrusions 112 may improve a coupling force between the frame substrate 110a and a liquid polymer precursor when manufacturing the cleaning device 100b. Also, after transforming the liquid crystal precursor into a functional membrane, for example, the first and second functional membranes 120 and 130, through a curing process, the protrusions 112 may improve a coupling force between the frame substrate 110a and the first and second functional membranes 120 and 130. Accordingly, a defect such as peeling of the first and second functional membranes 120 and 130 from the frame substrate 110a may be prevented during the cleaning process by using the cleaning device 100b.

Also, in the cleaning device 100b of the present example embodiment, the first and second functional membranes 120 and 130 may be formed on opposite surfaces of the frame substrate 110a, and the first and second functional membranes 120 and 130 may be formed of the same material as or different materials from each other. The lifespan of the cleaning device 100b may be improved when the first and second functional membranes 120 and 130 are used for the same purpose, or the cleaning device 100b may perform an additional function in addition to the cleaning function when the first and second functional membranes 120 and 130 are used for different purposes from each other.

Structures or materials of the frame substrate 110a and the first and second functional membranes 120 and 130 are the same as those described with reference to FIGS. 1A through 2.

Referring to FIG. 4, a cleaning device 100c according to the present example embodiment may further include a chemical action layer 140 on the frame substrate 110, unlike the cleaning device 100 of FIG. 2. The chemical action layer 140 may increase a coupling force between the frame substrate 110 and the first and second functional membranes 120 and 130.

The chemical action layer 140 may be formed by applying a treatment of a chemical agent, for example, hexamethyldisilazane (HMDS), on the frame substrate 110. The HMDS treatment is performed so that an attaching between a substrate and an organic layer may be made well, and through the HMDS treatment, a material layer that chemically reacts with an oxidation layer on the substrate and is physically coupled to the organic layer thereon may be formed.

In the present example embodiment, the chemical action layer 140 is formed on opposite surfaces of the frame substrate 110; however, the chemical action layer 140 may be formed on only one surface of the frame substrate 110. With the forming of the chemical action layer 140 or separately, a physical and/or chemical treatment is performed on the frame substrate 110 to improve the coupling force between the frame substrate 110 and the first and second functional membranes 120 and 130. The physical and chemical treatments of the frame substrate 110 are described with reference to FIGS. 1A through 2 above, and thus, descriptions thereof are not provided here.

Referring to FIG. 5, a cleaning device 100d of the present example embodiment may further include a chemical action layer 140 on the second functional membrane 130. The chemical action layer 140 may be a polymethylmethacrylate (PMMA) layer, a polydimethylsiloxane (PDMS) layer, or a self-assembly monolayer (SAM) layer. The PMMA layer may have a hydrophilic property and the PDMS layer may have a hydrophobic property. The SAM layer is an organic assembly monolayer formed by an absorption process, and thus, may have a strong hydrophobic property. Owing to the hydrophobic property, the PDMS layer and the SAM layer may recover a hydrophobic property or a water repellency of the surface of the support. The PMMA layer may be used to perform a hydrophilic surface modification; however, the PMMA layer is mostly used to perform the cleaning function.

In the cleaning device 100d of the present example embodiment, the chemical action layer 140 is formed only on the second functional membrane 130; however, the chemical action layer 140 may be formed on the first functional membrane 120. With the forming of the chemical action layer 140 or separately, a physical and/or chemical treatment may be performed on at least one of the first and second functional membranes 120 and 130 to improve the performance of the first or second functional membrane 120 or 130.

On the other hand, in the cleaning device 100d of the present example embodiment, an adhesive layer (not shown) may be formed instead of the chemical action layer 140. The chemical action layer 140 may be formed on one of the functional membranes 120 and 130, and the adhesive layer may be formed on the other functional membrane 120 or 130. The adhesive layer is described with reference to FIGS. 1A through 2, and thus, descriptions thereof are not provided here.

Referring to FIG. 6, a cleaning device 100e of the present example embodiment may include a pattern 132 formed on a surface of a second functional membrane 130a. Therefore, performance of cleaning the surface of the support may be improved. For example, if a surface of the support that is to be cleaned has a predetermined pattern, the pattern 132 is formed on the surface of the second functional membrane 130a of the cleaning device 100e to correspond to the pattern of the support surface, in order to improve the cleaning function.

By forming the pattern 132 on the surface of the second functional membrane 130a, an entire surface area of the second functional membrane 130a is increased, thereby improving the cleaning function or other additional functions of the second functional membrane 130a. For example, if the functional membrane in which the pattern 132 is formed, for example the second functional membrane 130a, is disposed opposite to the surface of the support, performances of the cleaning function or the additional functions such as the sampling or the degassing may be improved due to the increased surface area.

In the cleaning device 100e of the present example embodiment, the pattern 132 is formed only on the surface of the second functional membrane 130a. However, the pattern may be formed on the surface of the first functional membrane 120.

The pattern 132 formed on the surface of the first functional membrane 120 or the surface of the second functional membrane 130a may have a very small size. For example, the pattern on the functional membrane may be formed to have concave-convex pattern having an average surface roughness (Ra) of about 0.10 μm or greater, in particular, 0.10 to 1.0 μm. As described above, since the functional membrane includes the concave-convex pattern, impurities of a certain size, for example, a particle diameter of about 0.2 to 2.0 μm, may be removed efficiently.

The concave-convex pattern on the functional membrane may be formed as, for example, a recess shape, a stripe, a protrusion, a dimple, or a rough surface such as that of sandpaper.

So far, structures of the cleaning device according to the example embodiments have been described. However, example embodiments are not limited to the above structures. For example, the technical gist of example embodiments of inventive concepts may be applied to all kinds of cleaning devices, in which the functional membranes are formed on opposite surfaces of the frame substrate using the same material or different materials from each other to be used for the same purpose or different purposes from each other.

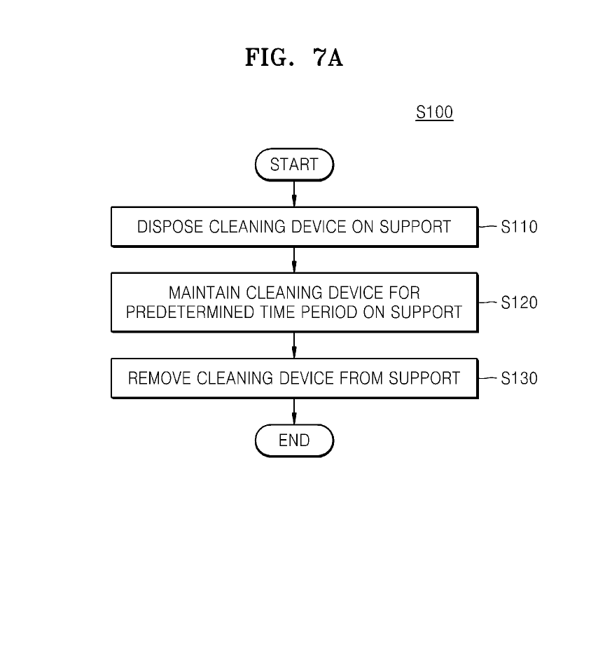

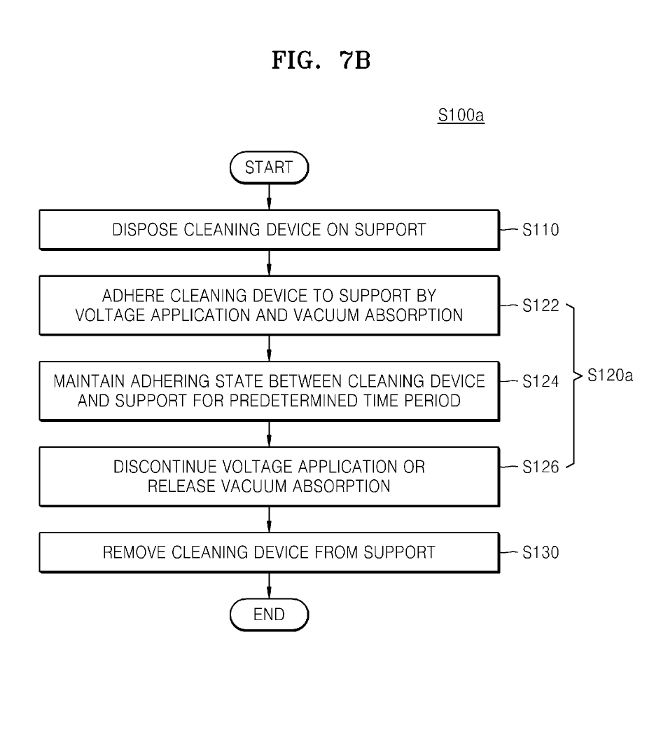

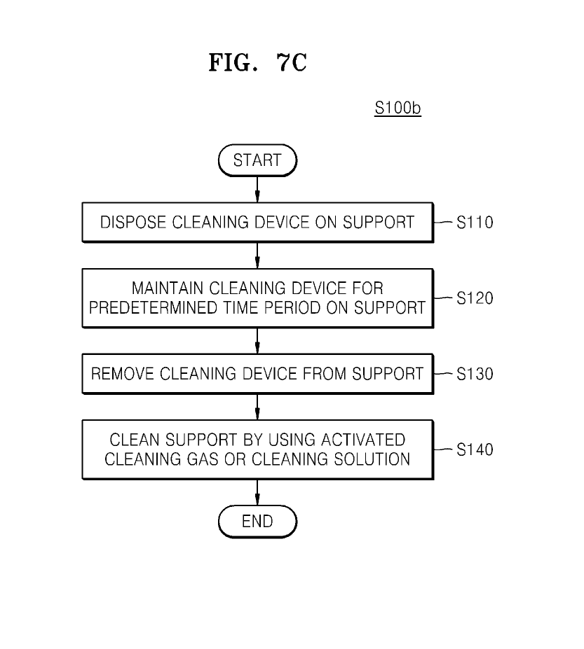

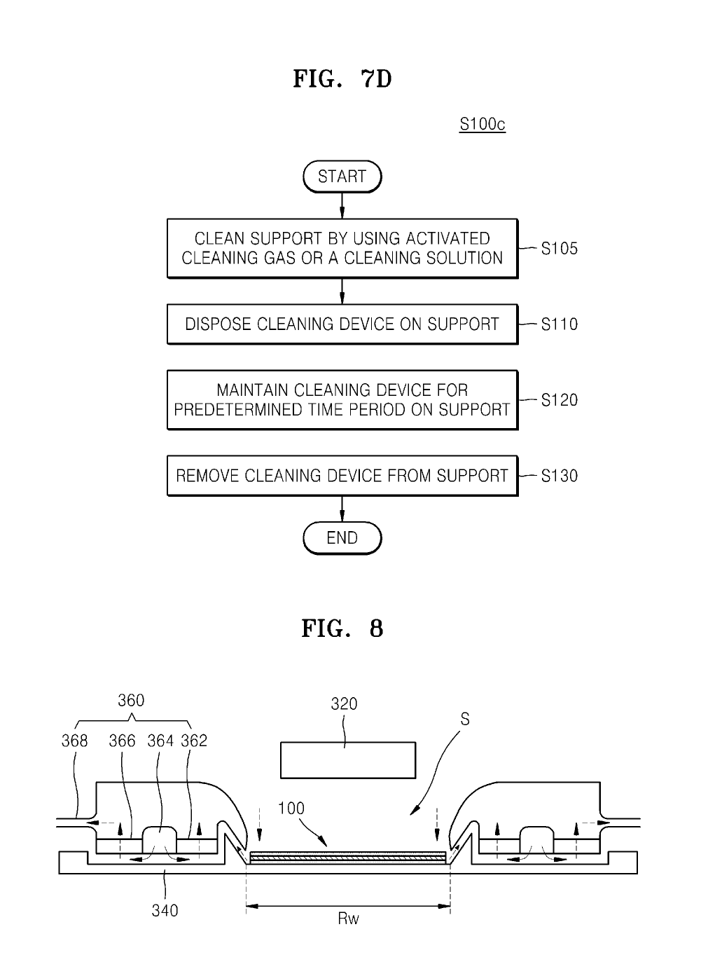

FIGS. 7A through 7D are flowcharts illustrating a cleaning method according to an example embodiment of inventive concepts, and for convenience of comprehension, the descriptions are made with reference to FIGS. 1A and 2.

Referring to FIG. 7A, according to a cleaning method S100 according to the present example embodiment, the cleaning device 100 is disposed on the support (S110). The cleaning device 100 may include the frame substrate 110 and the first and second functional membranes 120 and 130 formed on opposite surfaces of the frame substrate 110, as described above with reference to FIGS. 1A and 2. The cleaning devices described with reference to FIGS. 3 through 6 may be applied to the cleaning method S100 according to the present example embodiment.

The cleaning device 100 is moved by a conveying device that moves a substrate to the support to be placed on the support. Accordingly, the cleaning device 100 may have the structure that is the same as or similar to that of the substrate. Also, since the cleaning device 100 is placed on the support by the conveying device that is used to move the substrate, there is no need to stop the operation of the processing equipment in order to place the cleaning device 100 on the support. However, example embodiments of inventive concepts do not exclude a case where the processing equipment stops operating.

Positioning the cleaning device 100 on the support may vary depending on the kind of the functional membranes formed on the cleaning device 100. For example, if the functional membranes formed on the opposite surfaces of the frame substrate 110 are formed of the same material as each other, the cleaning device 100 may be disposed so that any one of the two functional membranes may contact the surface of the support. However, although the two functional membranes are formed of the same material, the cleaning device 100 may be disposed on the support according to predetermined rules in order to increase the lifespan of the cleaning device 100. For example, the cleaning device 100 may be disposed so that one of the functional membranes, for example, the first functional membrane 120, may contact the surface of the support continuously for a predetermined number of cleaning processes, and after that, the cleaning device 100 may be turned over so that the other functional membrane, for example, the second functional membrane 130, may contact the surface of the support. When the second functional membrane 130 contacts the surface of the support continuously for the predetermined number of cleaning processes, the corresponding cleaning device 100 may be discarded. Otherwise, the cleaning device 100 may be disposed so that the functional membranes 120 and 130 may alternately contact the surface of the support for each cleaning process, and when the functional membranes 120 and 130 each respectively contact the surface of the support by the predetermined number of cleaning processes, the corresponding cleaning device 100 may be discarded.

Otherwise, changing of the functional membrane or the discarding of the cleaning device 100 may be determined based on other criteria, in addition to the predetermined number of cleaning processes. For example, after testing a contamination degree or an amount of impurities of one of the functional membranes, the functional membrane on the contacting side of the cleaning device 100 may be changed if the test result exceeds a predetermined reference. If the contamination degrees or the amounts of the impurities of both of the functional membranes 120 and 130 exceed the predetermined reference, the cleaning device 100 may be discarded.

The cleaning device 100 is maintained for a predetermined time period on the support (S120). The predetermined time period may be sufficient to remove the impurities on the support. For example, the predetermined time period may range from 0.1 to 30 minutes, or in particular, from 0.5 to 5 minutes. Alternately, the predetermined time may be determined according to a processing time of a substrate on the support. By setting the cleaning time to be similar to the processing time of the substrate, the processing stability in the equipment may be improved.

However, if the purpose of the cleaning device 100 is to perform the sampling, the degassing, or the surface modification of the support, instead of or in addition to cleaning the support, the predetermined time period may be appropriately determined according to the corresponding purpose.

After applying the cleaning device 100 to the support, the cleaning device 100 is removed from the support (S 130). The removal of the cleaning device 100 may be performed using the conveying device of the substrate, similar to the disposing of the cleaning device 100 on the support. The cleaning device 100 may be located in a container, in which substrates stand by for processing, or in another place. When the cleaning device 100 is located with the substrates in the container, the disposing of the cleaning device 100 and isolation of the cleaning device 100 to/from the support may be performed in the same manner as that of the disposing and isolating of the substrate to/from the support via the conveying device.

Referring to FIG. 7B, a cleaning method S100a according to the present example embodiment may include a more active way for adhering the cleaning device 100 to the support, as well as a process for disposing the cleaning device 100 and maintaining the posture of the cleaning device 100 for a predetermined time.

For example, after disposing the cleaning device 100 on the support (S110), the cleaning device 100 is adhered to the support by a voltage application or a vacuum absorption (S122). The adhering state between the cleaning device 100 and the support may be maintained for a predetermined time period (S124). The predetermined time period may be, for example, between 0.1 and 30 minutes, or in particular, between 0.5 and 5 minutes. As the adhering state according to the cleaning method S100a of the present example embodiment is stronger than that according to the cleaning method S100 illustrated in FIG. 7A, the predetermined time period may be shorter than that of the cleaning method S100 illustrated in FIG. 7A. After maintaining the adhering state for the predetermined time period, the voltage application is discontinued or the vacuum absorption is released (S126). Processes using the voltage application or the vacuum absorption (S122) to maintain the cleaning device 100 on the support and the release of the voltage application or the vacuum absorption (S126) may correspond to a process of maintaining the cleaning device 100 on the support (S120a) in the cleaning method S100a of the present example embodiment.

After the maintaining of the cleaning device 100 on the support (S120a), the cleaning device 100 is removed from the support (S130) as in the cleaning method S100 illustrated in FIG. 7A.

Referring to FIG. 7C, a cleaning method S100b according to the present example embodiment may further include a process of cleaning the support using an activated cleaning gas or a cleaning solution (S140), after the removing of the cleaning device 100 from the support (S130). According to the cleaning method S100b of the present example embodiment, after cleaning the support using the cleaning device 100, the support is cleaned once again using another cleaning method, thereby improving a degree of cleanness of the support.

Referring to FIG. 7D, a cleaning method S100c according to the present example embodiment may further include a process of cleaning the support using an activated cleaning gas or a cleaning solution (S105), before disposing the cleaning device 100 on the support (S130). According to the cleaning method S100c of the present example embodiment, before cleaning the support using the cleaning device 100, the support is cleaned using another cleaning method, and then is cleaned again using the cleaning device 100, thereby improving the degree of cleanness of the support.

According to the cleaning methods S100b and S100c illustrated in FIGS. 7C and 7D, after removing the cleaning device 100 from the support (S130) or before disposing the cleaning device 100 on the support (S110), the support is cleaned using another cleaning method. However, example embodiments of inventive concepts may vary and are not limited thereto. For example, after removing the cleaning device 100 from the support (S130) and before disposing the cleaning device 100 on the support (S110), the support may be cleaned using different cleaning methods.

In the cleaning methods S100b and S100c illustrated in FIGS. 7C and 7D, the cleaning process using the cleaning device 100 may be a physical cleaning for removing impurities of various sizes on the support through the adhesion, and then the cleaning process using the another cleaning method may be a chemical cleaning that uses chemical reactions to remove impurities. However, the cleaning process using the cleaning device 100 does not exclude the chemical cleaning process.

Although not shown in the drawings, the cleaning methods may not be terminated upon first completion, but may be repeatedly performed, thereby improving the degree of cleanness of the support.

Example embodiments of inventive concepts are not limited to the above described cleaning method, but may be applied to other various cleaning methods of cleaning the support using the cleaning device having opposite surfaces, on which functional membranes are formed.

FIG. 8 is a conceptual view of applying the cleaning method according to an example embodiment of inventive concepts to an immersion lithography process.

Referring to FIG. 8, the immersion lithography process includes a lens 320 for transferring light output from an exposure unit to a wafer (not shown), a wafer stage 340 for moving the wafer in a fixed state, and an immersion hood 360 for allowing a space between the lens 320 and the wafer stage 340 to be filled with water. The immersion hood 360 may include a first suction unit 362 for sucking water flowing from a space S between a region Rw on which the wafer is fixed in the wafer stage 340 and the lens 320, an air injection unit 364 for applying an air pressure so as to prevent leakage of the water from the space S, a second suction unit 366 for sucking water flowing out of the air injection unit 364, and a discharge path 368 for discharging the water sucked through the first and second suction units 362 and 366 to outside. A dotted line arrow denotes flow of water, and a solid line arrow denotes flow of air.

The immersion hood 360 used in the immersion lithography process may allow liquid to flow at a rate of about 1.0 to 1.4 liter per minute between the lens 320 and the wafer stage 340 so that the space S is filled with the liquid during the exposure process. Water may be used as the liquid for filling in the space S in the immersion lithography process.

Processes of the immersion lithography are as follows. HMDS may be deposited on a surface of the wafer and cooled down so that the surface of the wafer may have a hydrophobic property. A bottom anti-reflection layer may be applied to the wafer, and then annealed and cooled down. A photosensitive material may be applied on the wafer, and then annealed and cooled down. After coating the photosensitive material, a protective layer for protecting the photosensitive material may be applied, and then annealed and cooled down to perform a wafer edge exposure (WEE) process. The wafer may be cleaned (pure water process), and the wafer may be mounted on the region Rw where the wafer is fixed on the wafer stage 340. The wafer stage 340 may be moved to a lower portion of the lens 320, and a location of the wafer stage 340 may be determined using coordinate information and focusing may be performed. The immersion hood 360 may be mounted so that a space S between the lens 320 and the wafer stage 340 is filled with water and an exposure process is performed. The immersion hood 360 may be isolated, and the wafer may be carried out and cleaned (pure water process). The wafer may be annealed and cooled down to perform a developing process.

In the immersion lithography process, a predetermined part of a photoresist applied on the wafer may be exposed to light transmitted through the lens 320 according to a desired pattern shape. If the photoresist applied on the wafer is a chemically amplified resist, an acid generator in the portion exposed to the light is decomposed to an acid and ion compound of a low molecular amount, and the photosensitive material of the high molecular amount may be decomposed to a low molecular amount compound.

When finishing the immersion lithography process, the residue such as the acid, the ion compounds, and the low molecular weight compounds are discarded with the water filled in the space S. However, the above residue may not be completely discharged, but partially remains on the wafer stage 340. In addition, as the immersion lithography process is repeatedly performed, the contamination on the wafer stage 340 becomes severe. Accordingly, defects may occur on a surface of a wafer or arranging error of the wafer may occur when the immersion lithography process is repeated, thereby increasing a wafer defective rate and reducing processing stability.

To address the above contamination problem, the immersion lithography apparatus, in particular, the wafer stage 340, may be cleaned with a cleaning period that is set according to a lot unit. The lot denotes a processing number unit of the wafer. Due to characteristics of the immersion lithography apparatus, the cleaning process may be performed after stopping the operation of the apparatus and a time gap between lots may be increased. However, if the time gap between the lots in the immersion lithography apparatus is a predetermined time period or longer, an overlay of the wafer pattern may be badly influenced by variations of temperature and air flow in the wafer stage or the immersion lithography apparatus. Accordingly, defects may occur in the wafer patterns. The overlay denotes an arrangement between patterns formed by previous and current processes.

However, since the cleaning device 100 according to the present example embodiment is formed to have a similar structure to that of the wafer on which the exposure process is performed, the cleaning process may be performed under the same processing conditions as those of the immersion lithography process. For example, the cleaning device 100 is disposed on the wafer stage 340 in the same manner as that of disposing the wafer on the wafer stage 340, maintained for a predetermined time, and then discharged in the immersion lithography process. Accordingly, the wafer stage 340 may be cleaned easily and simply. As the cleaning process is performed in the same manner as that of the wafer process, the temperature and the air flow in the apparatus and of the wafer stage 340 may be stabilized, and the immersion related components and the wafer stage 340 of the immersion lithography apparatus may be cleaned at the same time. Therefore, the cleaning process using the cleaning device 100 according to the present example embodiment may be performed without stopping the operation of the immersion lithography apparatus, and at the same time, functions required for cleaning the immersion lithography apparatus and stabilizing the immersion lithography apparatus may be performed.

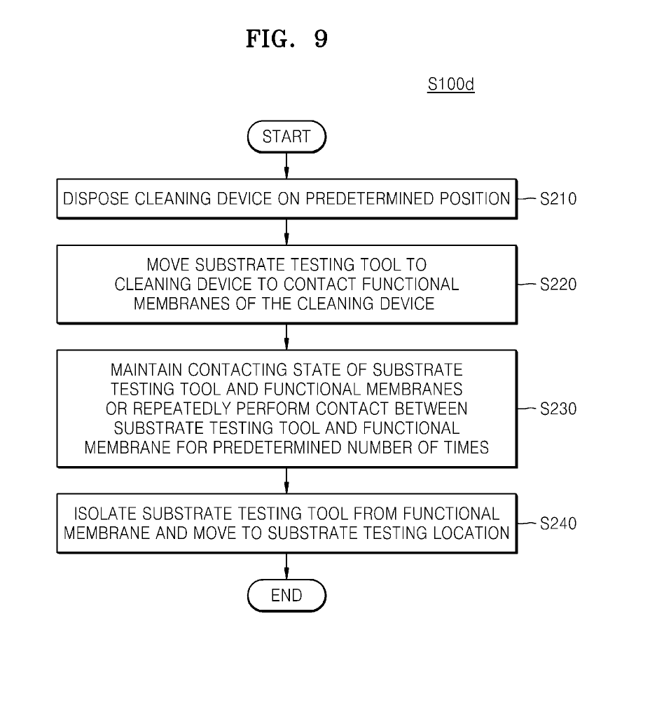

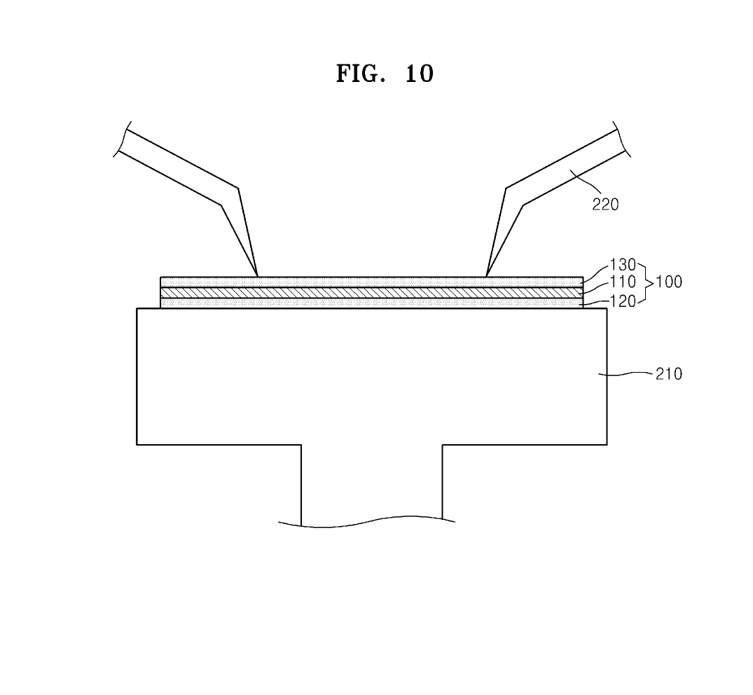

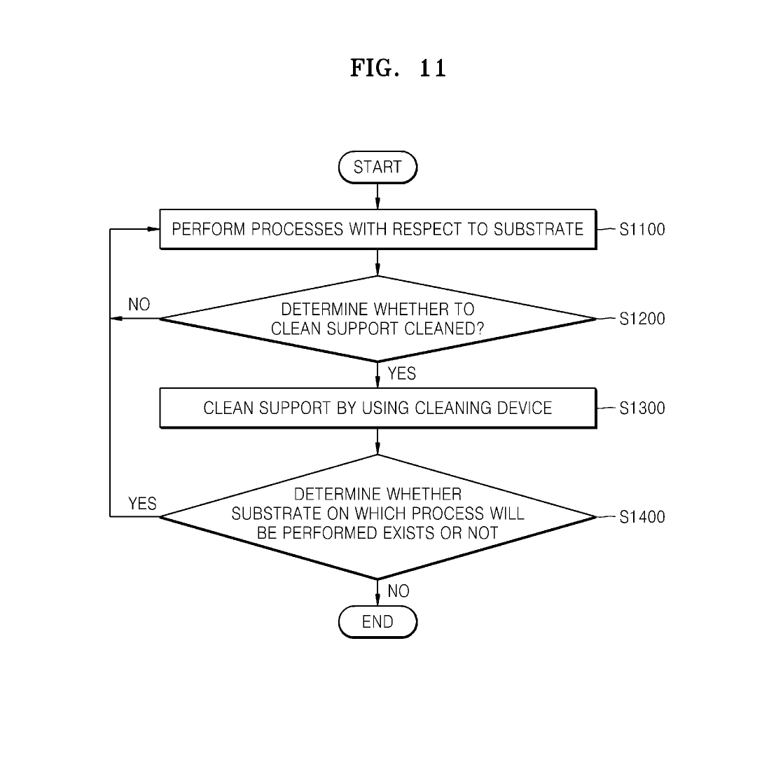

FIG. 9 is a flowchart illustrating a cleaning method S100d according to another example embodiment of inventive concepts, and FIG. 10 is a conceptual view of applying the cleaning method illustrated in FIG. 9 to a test apparatus.

Referring to FIG. 9, according to the cleaning method S100d of the present example embodiment, the cleaning device 100 is disposed on a predetermined location (S210). The cleaning device 100 may include the frame substrate 100, and the first and second functional membranes 120 and 130 formed on the opposite surfaces of the frame substrate 100, as described above with reference to FIGS. 1A and 2. The cleaning devices described with reference to FIGS. 3 through 6 may be used in the cleaning method according to the present example embodiment. Also, the cleaning device 100 may be disposed on a predetermined location by a conveying apparatus as described above.

The predetermined location may be a prober chuck 210 on which a wafer to be tested is loaded and moved to be tested. The predetermined location may be another location for performing the cleaning process besides the prober chuck 210.

A substrate testing tool is moved to the cleaning device 100 so as to contact the first and second functional membranes 120 and 130 of the cleaning device 100 (S220). The substrate testing tool may be a probe tip 220 of a prober machine. The prober machine is an apparatus that loads a substrate such as a wafer including a plurality of semiconductor chips onto the prober chuck 210, and contacts the probe tip 220 to the semiconductor chips to test electrical characteristics of the semiconductor chips.

The contact state between the substrate testing tool, for example, the probe tip 220 of the prober machine and the second functional membrane 130, is maintained for a predetermined time period, or the contact between the probe tip 220 of the probe machine and the second functional membrane 130 may be repeatedly performed for a predetermined number of times (S230). The probe tip 220 of the prober machine may be cleaned by maintaining the contact state between the probe tip 220 and the second functional membrane 130 for a predetermined time period, or by repeatedly contacting the probe tip 220 to the functional membrane 130 for a predetermined number of times.

It may be determined whether to maintain the contact state or to repeatedly perform the contact operation according to the probe tip structure and the cleaning degree of the prober machine. Example embodiments may vary, and the above methods may be used in combination with each other. For example, the contact operation may be repeatedly performed while each contacting state is maintained for a predetermined time period in order to perform the cleaning process.

The predetermined time period or the predetermined number of times may be determined to be sufficient to perform the cleaning process of the probe tip 220 of the prober machine. For example, the predetermined time period may range from 0.5 to 30 minutes, and the predetermined number of times may be two to twenty times.

When the maintaining of the contacting state of the substrate testing tool or the contact repetition process (S230) is finished, the substrate testing tool is isolated from the functional membrane and moved to a substrate testing location (S240).

When the testing of a plurality of wafers is performed using the prober machine, the probe tip 220 that repeatedly contacts the semiconductor chips is contaminated, thereby generating a test defect. Accordingly, the probe tip 220 of the prober machine needs to be cleaned in order to prevent the defects. According to the cleaning method S 100d of the present example embodiment, the cleaning device 100 having the opposite surfaces, on which the first and second functional membranes 120 and 130 are formed, is disposed on a prober chuck 210, and the probe tip 220 contacts the functional membranes 120 and 130 to perform the cleaning process in a similar way to the substrate testing process. Accordingly, the probe tip 220 may be cleaned simply and easily while maintaining the processing stability of the test process.

According to the cleaning method S100d of the present example embodiment, the functional membrane formed on one surface of the cleaning device 100, for example, the first functional membrane 120, contacts the surface of the prober chuck 210, and thus, the cleaning of the surface of the prober chuck 210 using the first functional membrane 120 may be performed in combination with the cleaning process of the probe tip 220 using the second functional membrane 130.

So far, the prober machine is described as an example; however, the cleaning method of the present example embodiment is not limited to the prober machine, but may be applied to all kinds of test devices including a tip-shaped testing tool.

FIG. 11 is a flowchart illustrating a method of manufacturing a device using a cleaning method according to an example embodiment of inventive concepts. For convenience of description, the method of the present example embodiment will be described with reference to FIGS. 1A and 2.

Referring to FIG. 11, according to the method of manufacturing a device of the present example embodiment, processes with respect to a substrate are performed first (S1100). The substrate may be a semiconductor wafer used in semiconductor manufacturing processes, or a substrate for flat panel displays such as PDP, LCD, LED, and OLED used in display manufacturing processes. Such a substrate is disposed on a support such as an electrostatic chuck or a vacuum chuck so that various corresponding processes, for example, an exposure process, a sputtering process, a CVD process, an ion implantation process, and an etching process, may be performed.

Next, it is determined whether the support is to be cleaned (S1200). As described above, when the processes with respect to the substrate are performed on the support, a surface of the support may become contaminated. Also, as the processes are repeatedly performed, the contamination degree may further increase. Therefore, there is a need to perform a cleaning process of the support to remove the contamination. It is not advantageous to perform the cleaning process of the support randomly in view of the processing stability. Therefore, it may be set so that the cleaning is performed after a process is performed a predetermined number of times or once predetermined conditions are satisfied. For example, it may be set so that the cleaning process is performed after processes are performed with respect to the predetermined number of lots. Otherwise, it may be set so that the cleaning process is performed if a contamination degree exceeds a reference after measuring the contamination degree of the support.

If it is determined that the support is to be cleaned (Yes), the support is cleaned using the cleaning device 100 (S1300). The cleaning device 100 may include the frame substrate 100, and the first and second functional membranes 120 and 130 formed on opposite surfaces of the frame substrate 100 as described with reference to FIGS. 1A and 2. The cleaning devices shown in FIGS. 3 through 6 may be applied to the cleaning method and one of the cleaning methods illustrated in FIGS. 7A through 7D may be used. Another cleaning method, in addition to the cleaning methods illustrated in FIGS. 7A through 7D, may be used. For example, the cleaning methods S100 and S100a of FIGS. 7A and 7B are not performed only once, but may be repeatedly performed, or the cleaning methods S100b and S100c shown in FIGS. 7C and 7D may be performed together. Moreover, cleaning of the support using the cleaning device, on which the functional membranes are formed on opposite surfaces, in various ways may be applied to the support cleaning process (S 1300) of the method of manufacturing the device of the present example embodiment.

If it is determined that the support is not to be cleaned (No), for example, if the process has not yet been performed a predetermined number of times or the predetermined conditions are not yet satisfied, the process goes to the operation of performing the processes with respect to a substrate (S1100) to perform the processes with respect to a new substrate.

After performing the cleaning process, it is determined whether a substrate on which the process will be performed exists or not (S1400). If there is no substrate on which the corresponding process will be performed (No), the manufacturing process of the device is finished. If there is a substrate on which the corresponding process will be performed (Yes), processes with respect to the new substrate are performed (S1101). As the cleaning process is generally performed according to a lot unit, the determination of the substrate existence may be performed according to the lot unit. For example, it is determined whether there is a lot in which the corresponding process will be performed, and then, if there is the lot (Yes), the process for the substrate is performed (S1100), and if not (No), the device manufacturing process is finished.

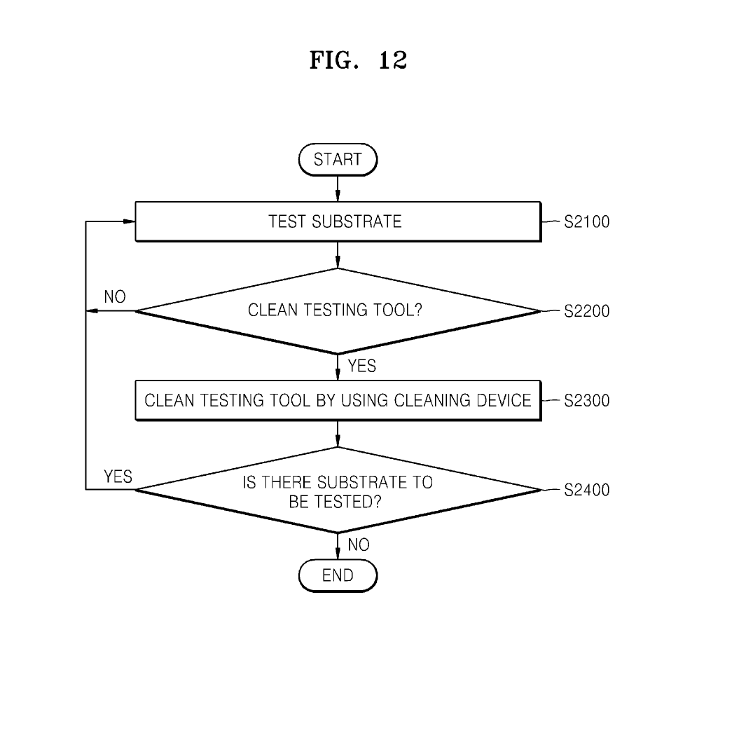

FIG. 12 is a flowchart illustrating a method of manufacturing a device using a cleaning method, according to another example embodiment of inventive concepts. For convenience of description, the manufacturing method of the present example embodiment will be described with reference to FIGS. 1A and 2.

Referring to FIG. 12, according to the method of manufacturing a device, a substrate is tested first (S2100). The test may denote a test of electrical performance of a substrate level using a prober machine, before packaging a device; however, a test for the substrate of the packaged state is not excluded here.

Step S2200 determines whether a testing tool is to be cleaned. As described above with reference to FIGS. 9 and 10, when the test of the substrate using the testing tool, for example a probe tip of the prober machine, is performed, the testing tool may become contaminated. As the test is repeatedly performed, the contamination degree of the testing tool may become worse. Therefore, the testing tool needs to be cleaned to remove the contamination. It may be set so that the cleaning of the testing tool may be performed after the testing tool is used a predetermined number of times or when a predetermined condition is satisfied. For example, the testing tool may be cleaned after the test is performed with respect to the predetermined number of lots. Otherwise, the testing tool may be cleaned when a contamination degree exceeds a reference based on a measurement of the contamination degree of the testing tool.

If it is determined that the testing tool is to be cleaned (Yes), the testing tool is cleaned using the cleaning device 100 (S2300). The cleaning method illustrated in FIG. 9 may be used. Another cleaning method besides the cleaning method S 100d illustrated in FIG. 9 may be used; for example, another cleaning method that is different from the cleaning method illustrated in FIG. 9 may be used by using the cleaning device having the functional membranes on opposite surfaces thereof according to the present example embodiment. Further, the support on which the substrate is disposed or positioned on to be tested may be cleaned with the testing tool according to the structure of the cleaning device 100 of the present example embodiment.

If it is determined that the testing tool is not to be cleaned (No), for example, if the process has not yet been performed a predetermined number of times or the predetermined condition is not satisfied, a new substrate is tested (S2100).

After cleaning the testing tool, it is determined whether there is a substrate that will be tested (S2400). If there is no substrate to be tested (No), the manufacturing process of the device is finished. If there is a substrate to be tested (Yes), testing of the substrate is performed (S2100). The determination whether there is the substrate to be tested may be performed based on a lot unit.

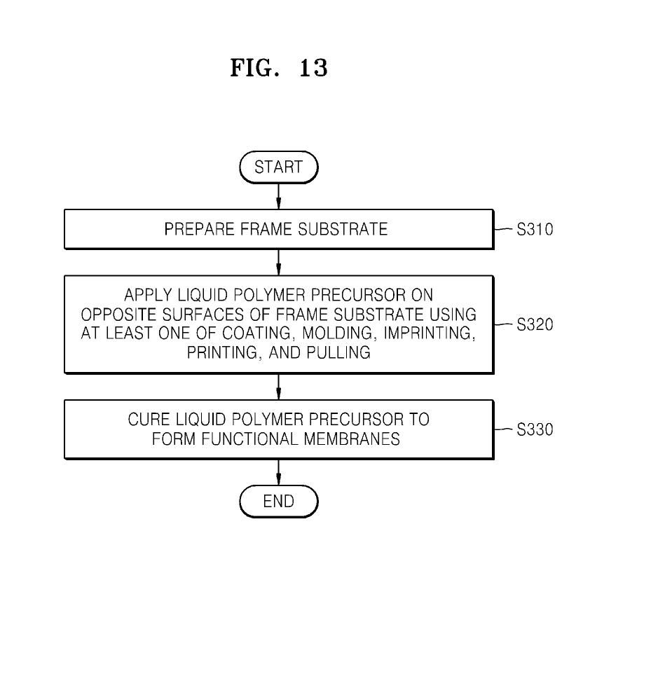

FIG. 13 is a flowchart illustrating a method of manufacturing a cleaning device according to an example embodiment of inventive concepts. The method of the present example embodiment will be described with reference to FIGS. 1A and 2 for convenience of description.

Referring to FIG. 13, according to the method of manufacturing the cleaning device, the frame substrate 110 is prepared (S310). The frame substrate 110 configures a frame of the cleaning device 100, and may support the first and second functional membranes 120 and 130 formed on upper and lower surfaces thereof. For example, the frame substrate 110 may include at least one dielectric material and/or semiconductor material among aluminum oxide, quartz, glass, silicon, engineering plastic, and super engineering plastic. The frame substrate 110 may also include at least one metal material from among aluminum, aluminum alloy, stainless steel, and titanium.

Surfaces of the frame substrate 110 may undergo general surface treatment in order to improve an adhesion property and a maintenance property with adjacent layers, for example the first and second functional membranes 120 and 130. The frame substrate 110 may be configured to have a single-layered structure or a multi-layered structure. The frame substrate 110 may have various horizontal cross-sectional structures, for example, circular shapes, oval shapes, and polygonal shapes.

Liquid polymer precursor is applied on opposite surfaces of the frame substrate 110 (S320). The liquid polymer precursor may be applied using at least one of coating, molding, imprinting, printing, and pulling operations. The coating may denote a spray coating or a spin coating. The molding may denote a compression molding, an injection molding, a lamination molding, a roll molding, or a replica molding. The molding may also denote a casting molding or casting for fabricating a product by filling a material in a mold and drying the material.

The imprinting method is a method of transferring a pattern formed on a stamp onto a substrate by contacting the stamp with the substrate. The imprinting method may denote a method of obtaining a substrate on which a pattern is transferred by contacting a stamp to a flexible target and curing the flexible target. Also, the imprinting method may denote a rolling imprinting method that transfers a pattern through a rolling process. The imprinting method may be used together with the above described molding method.

The printing method may denote an inkjet printing method that is generally used when a pattern is printed on a substrate such as an LCD, an OLED, or a printed circuit board (PCB). Accordingly, the method of manufacturing the cleaning device according to the present example embodiment may include a process for forming a pattern on the cleaning device by using the inkjet printing method.

A pulling method is used to form a single crystalline. For example, for a material that is contained in a container, a seed of the single crystalline is pulled up while rotating the seed slowly under a constant temperature to generate a silicon single crystalline. The cleaning device of the present example embodiment may be manufactured using the pulling method.

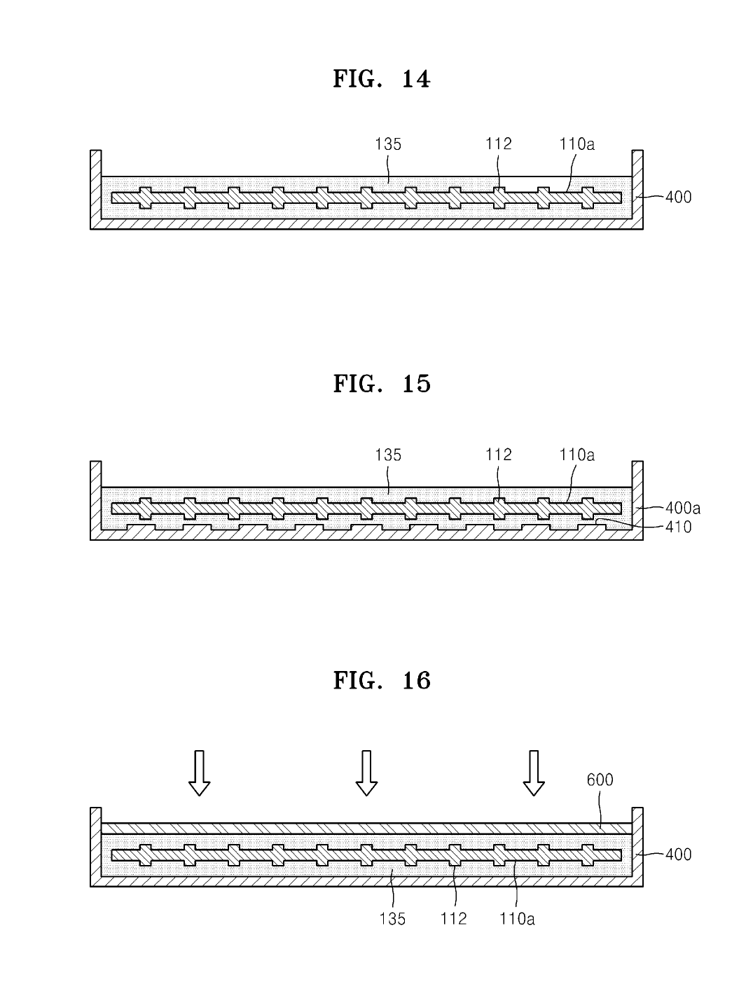

The application of the liquid polymer precursor on the frame substrate 110 will be described below with reference to FIGS. 14 through 19.

After applying the liquid polymer precursor, the liquid polymer precursor is cured to form the first and second functional membranes 120 and 130 (S330). The liquid polymer precursor may be cured using at least one method of a catalyst curing, a photo curing, a thermal curing, a dual curing, and a natural curing method. The photo curing method may denote a UV curing. Also, the dual curing denotes a mixture of two curing methods, and the natural curing method may denote a drying process performed naturally. The curing method may be appropriately selected according to the material of the liquid polymer precursor. Also, the curing method may be selected according to performances of the functional membranes that will be formed.

Although the same liquid polymer precursor is applied to the opposite surfaces of the frame substrate 110, the functional membranes formed on the opposite surfaces of the frame substrate 110 may have different characteristics from each other according to the curing methods. For example, the liquid polymer precursor formed on a surface may be cured at a relatively low temperature, and the liquid polymer precursor formed on another surface may be cured at a relatively high temperature. Accordingly, the functional membrane formed by the low temperature curing may be soft, and the functional membrane formed by the high temperature curing may be hard and durable.

After curing the liquid polymer precursor, the cleaning device 100 shown in FIGS. 1A and 2 may be completed. After the curing process, the chemical or physical treatment of the functional membranes, or the coating process using an adhesive material such as the HMDS or the SAM may be performed. Also, an adhesive layer or a protective film may be formed on the functional membrane.

FIG. 14 is a conceptual view showing a method of manufacturing a cleaning device according to an example embodiment of inventive concepts.

Referring to FIG. 14, after disposing or positioning a frame substrate 110a in a mold container 400, a liquid polymer precursor 135 is filled in the mold container 400 and cured to fabricate the cleaning device 100b shown in FIG. 3. The mold container 400 may have a structure that is varied depending on a structure of the cleaning device that will be formed. The mold container 400 may have a cylindrical structure having a circular boundary of a predetermined height in order to form the cleaning device to correspond to the shape of a wafer. An inner diameter of the cylindrical shape may correspond to a diameter of the cleaning device that is to be formed.

In the present example embodiment, the frame substrate 110a having a plurality of protrusions in the cleaning device 100b of FIG. 3 is used; however, the frame substrate may have different shapes. For example, the frame substrate 110 having no protrusion may be disposed in the mold container 400 so as to manufacture the cleaning device 100 as shown in FIG. 2.

An amount of the liquid polymer precursor 135 may be appropriately adjusted according to a thickness of the functional membrane to be formed. After filling the liquid polymer precursor 135 in the mold container 400, the location of the frame substrate 110a may be adjusted. The location of the frame substrate 110a is adjusted in order to adjust the thickness of the functional membranes formed on the opposite surfaces of the frame substrate 110a. For example, by placing the frame substrate 110a at an intermediate height in the mold container 400, the functional membranes formed on the opposite surfaces of the frame substrate 110a may have equal thicknesses.

One of the catalyst curing, the photo curing, the thermal curing, the dual curing, and the natural curing methods may be selected according to the material of the liquid polymer precursor 135 or the functions of the functional membranes to be formed.

The method of manufacturing the cleaning device according to the present example embodiment manufactures the cleaning device without applying any kind of physical power to the cleaning device from outside, and thus, the method may be referred to as a cast molding method.

FIGS. 15 through 19 are conceptual views showing methods of manufacturing the cleaning device according to example embodiments of inventive concepts.

Referring to FIG. 15, according to the method of manufacturing the cleaning device of the present example embodiment, a mold container 400a may have a different structure from that of the mold container 400 shown in FIG. 14. For example, a pattern 410 may be formed on a bottom surface of the mold container 400a. As such, by forming the pattern 410 on the bottom surface of the mold container 400a, an opposite pattern may be formed on the surface of the functional membrane that corresponds to the bottom surface of the mold container 400a. For example, when the liquid polymer precursor 135 is cured in the mold container 400a to form the functional membranes, a pattern 132 is formed on a surface of the second functional membrane 130 as in the cleaning device 100e shown in FIG. 6. The cleaning device 100e shown in FIG. 6 corresponds to a shape of the liquid polymer precursor 135 that is cured in the mold container 400a and then turned over.

Since the cleaning device 100e has the pattern transferred from the bottom surface of the mold container 400a, the method of manufacturing the cleaning device of the present example embodiment may adopt the cast molding method and the imprinting method.

Referring to FIG. 16, the cleaning device 100b may be manufactured using a mold lid 600 formed as a lid. For example, after disposing the frame substrate 110a in the mold container 400, the liquid polymer precursor 135 is filled in the mold container 400, and the mold lid 600 covers the mold container 400 and a pressure is applied in a direction denoted by arrows to form the cleaning device 100b shown in FIG. 3. Then, the curing process may be performed in a state where the mold lid 600 still covers the mold container 400 after applying the pressure, or in a state where the mold lid 600 has been removed.

When the cleaning device 100b is manufactured by applying the pressure using the mold lid 600 as in the present example embodiment, the functional membranes having dense film quality may be obtained, and the cleaning device 100b may be formed having the exact desired structure. Also, the functional membrane may have a smooth surface corresponding to a surface of the mold lid 600.

Although not shown in FIG. 16, by forming a pattern on the mold lid 600, a pattern may be formed on a corresponding surface of the functional membrane. Also, when the patterns are formed on both the bottom surface of the mold container 400 and the surface of the mold lid 600, the functional membranes 120 and 130 formed on the opposite surfaces of the frame substrate 110a may have the patterns.

The method of manufacturing the cleaning device of the present example embodiment may refer to a compression molding method, because the cleaning device is manufactured while a pressure is applied thereto. When the patterns are formed on the mold container 400 and/or the mold lid 600, the imprinting method is performed together with the compression molding process.

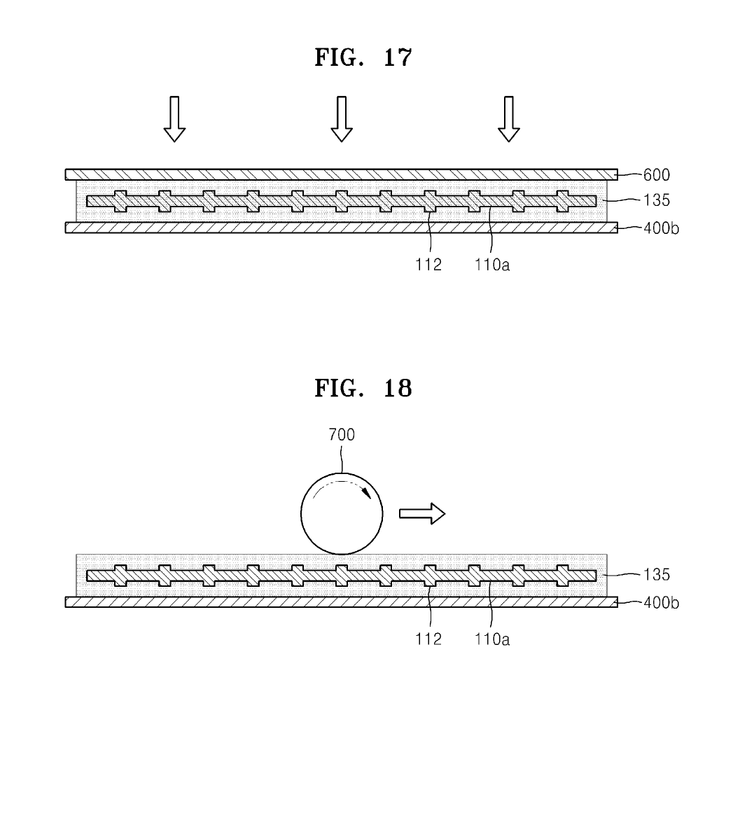

Referring to FIG. 17, according to the method of manufacturing the cleaning device of the present example embodiment, the cleaning device 100b may be manufactured using a mold plate 400b having a different structure from that of the mold container 400, with the mold lid 600. Since the liquid polymer precursor 135 has a viscosity to some degree, the mold plate 400b formed as a plate having no boundary may be used, in a case where the cleaning device 100b to be manufactured needs to have a relatively small thickness and a wide horizontal cross-sectional area.

Also, although the pressure may be applied via the mold lid 600, a pressure is applied from a side surface to discharge the cleaning device to another side surface. If the pressure is applied simply through the mold lid 600, the method of the present example embodiment corresponds to the compression molding method, and if the pressure is applied from the side surface to discharge the cleaning device 100b to another side surface, the method of the present example embodiment corresponds to the injection molding method. Also, by forming a pattern on the mold lid 600 or the mold plate 400b, the imprinting method for transferring the pattern onto the functional membrane may be performed.

Similar to FIG. 16, the curing may be performed in a state where the mold lid 600 covers the mold plate 400b or after the mold lid 600 has been removed.

Referring to FIG. 18, according to the method of manufacturing the cleaning device according to the present example embodiment, the mold plate 400b is used as in the method of FIG. 17; however, a rolling tool 700 is used instead the mold lid 600, in order to manufacture the cleaning device 100b. The rolling tool 700 rotates in a direction to apply pressure to the liquid polymer precursor 135.

The method of manufacturing the cleaning device 100b using the rolling tool 700 may correspond to the roll molding method. If a pattern is formed on the mold plate 400b or the rolling tool 700 so that the pattern is transferred onto the functional membrane, it may be considered that the imprinting method is performed in combination with the roll molding method. In particular, when the pattern is formed on the rolling tool 700 and the pattern is transferred while rolling the rolling tool 700, the method of the present example embodiment may correspond to a rolling imprinting method.

The curing may be performed during the rolling of the rolling tool 700 or may be performed after finishing the rolling operation.

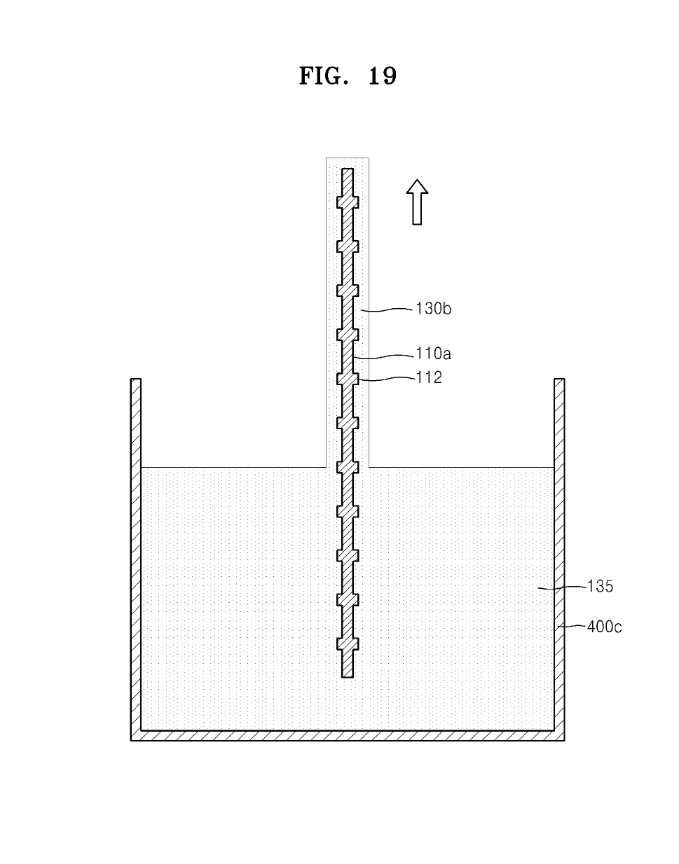

Referring to FIG. 19, the cleaning device may be manufactured in a totally different way from that of the previous example embodiments. For example, according to the method of manufacturing the cleaning device of the present example embodiment, the cleaning device 100b is manufactured using a pulling method. The pulling method is generally used to form a single crystalline; however, the pulling method may be used to manufacture the cleaning device 100b as in the present example embodiment.

For example, after filling the liquid polymer precursor 135 in a container 400c for the manufacture of the cleaning device 100b by the pulling method, the frame substrate 110a is dipped in the liquid polymer precursor 135 and is pulled up at very slow speed, thereby manufacturing the cleaning device 100b. When the frame substrate 110a is pulled upward, the liquid polymer precursor 135 is naturally cured so that pseudo functional membranes 130b having similar characteristics as those of final functional membranes may be formed on opposite surfaces of the frame substrate 110a.

When the pseudo functional membranes 130b are further cured naturally or by other curing methods, the first and second functional membranes 120 and 130 may be formed on the opposite surfaces of the frame substrate 110a.

While example embodiments of inventive concepts have been particularly shown and described with reference to some example embodiments thereof, it will be understood that various changes in form and details may be made therein without departing from the spirit and scope of the following claims.

What is claimed is:

1. A cleaning device comprising:
a frame substrate configured to frame the cleaning device;
a first functional membrane on a first surface of the frame substrate; and
a second functional membrane on a second surface of the frame substrate, wherein the second surface is opposite to the first surface.

2. The cleaning device of claim 1, wherein the first functional membrane and the second functional membrane are a same material.

3. The cleaning device of claim 1, wherein the first functional membrane and the second functional membrane are different materials from each other.

4. The cleaning device of claim 1, wherein the first and second functional membranes may include at least one of an organic material, an inorganic material, and a polymer material.

5. The cleaning device of claim 1, wherein at least one of the frame substrate, the first functional membrane, and the second functional membrane includes a chemical action layer or is physically or chemically treated.

6. The cleaning device of claim 1, wherein the cleaning device has one of a horizontal cross-section corresponding to a surface shape of a device that is to be cleaned, and a horizontal cross-section of a substrate supported by the device that is to be cleaned.

7. The cleaning device of claim 1, wherein at least one of the first functional membrane and the second functional membrane has a multi-layered structure.

8. The cleaning device of claim 1, wherein a pattern is formed on a surface of at least one of the first functional membrane and the second functional membrane.

9. The cleaning device of claim 1, wherein the frame substrate includes a plurality of protrusions configured to improve a coupling force to the first functional membrane and the second functional membrane.

10. A cleaning method comprising:
positioning a cleaning device including a frame substrate, a first functional membrane and a second functional membrane, the first functional membrane and the second functional membrane on opposite surfaces of the frame substrate, on a support configured to support a substrate, during a semiconductor manufacturing process or a display manufacturing process on the substrate;
maintaining the positioning of the cleaning device on the support for a predetermined time period; and
removing the cleaning device from the support.

11. The cleaning method of claim 10, wherein
the first functional membrane and the second functional membrane are a same material, and
after contacting the first functional membrane to the support a predetermined number of times, the cleaning device is turned over to contact the second functional membrane to the support, the first functional membrane on a first surface of the frame substrate and the second functional membrane on a second surface of the frame substrate.

12. The cleaning method of claim 10, wherein
the first functional membrane and the second functional membrane are different materials from each other,
the first functional membrane cleans the support, and
the second functional membrane does not contact the support and performs a function that is different from the cleaning of the support.

13. The cleaning method of claim 10, wherein cleaning is performed without stopping operations of an apparatus performing the semiconductor manufacturing process or the display manufacturing process on the substrate.

14. The cleaning method of claim 13, wherein the cleaning is performed without changing processing conditions in the apparatus.

15. The cleaning method of claim 10, wherein the cleaning device is configured to perform a cleaning function to clean the support and also to perform at least one additional function selected from the group consisting of contamination control, temperature stabilization, composition state maintenance, sampling, degassing, and recovery of hydrophobicity of the support in an apparatus in which the support is disposed.

16. The cleaning method of claim 10, wherein the maintaining of the positioning of the cleaning device includes adhering the cleaning device to the support by a voltage application or a vacuum absorption.

17. The cleaning method of claim 10, further comprising cleaning the support using a cleaning gas or a cleaning solution before the positioning the cleaning device or after the removing the cleaning device.

18. A method of manufacturing a device, the method comprising:
performing processes with respect to a substrate on a support configured to support the substrate, during a semiconductor manufacturing process or a display manufacturing process;
determining whether the support needs to be cleaned;
when the support needs to be cleaned, cleaning the support using a cleaning device including a frame substrate, and a first functional membrane and a second functional membrane formed on opposite surfaces of the frame substrate; and
positioning a new substrate on the support.

19. The method of claim 18, wherein the cleaning of the support comprises:
positioning the cleaning device on the support;
maintaining the positioning of the cleaning device on the support for a predetermined time period; and
removing the cleaning device from the support.

20. The method of claim 18, wherein when the first functional membrane and the second functional membrane are a same material, after contacting the first functional membrane to the support by a predetermined number of times, the cleaning device is turned over to contact the second functional membrane to the support, the first functional membrane on a first surface of the frame substrate and the second functional membrane on a second surface of the frame substrate.

21. The method of claim 18, wherein when the first functional membrane and the second functional membrane are different materials from each other, the first functional membrane contacts and cleans the support, and the second functional membrane performs a function that is different from the cleaning of the support.

22. The method of claim 18, wherein the cleaning is performed without stopping operations of an apparatus performing the semiconductor manufacturing process or the display manufacturing process on the substrate.

23. The method of claim 18, wherein the determining whether the support needs to be cleaned further comprises:
determining if at least one of a predetermined number of processing times with respect to the substrate and a predetermined condition in a processing apparatus is satisfied.

24. A method of manufacturing a cleaning device, the method comprising:
preparing a frame substrate configuring a frame of the cleaning device;
applying a liquid polymer precursor on each of opposite surfaces of the frame substrate using at least one of a coating method, a molding method, an imprinting method, a printing method, and a pulling method; and
forming functional membranes on the opposite surfaces of the frame substrate by curing the liquid polymer precursor.

25. The method of claim 24, wherein at least one of the frame substrate and the functional membranes on the opposite surfaces of the frame substrate includes a chemical action layer or is physically or chemically treated.

26. A cleaning device, comprising:
a substrate;
a first functional membrane on a first surface of the substrate, the first functional membrane configured to clean; and
a second functional membrane on a second surface of the substrate opposite the first surface, the second functional membrane configured to one of clean, control contamination, stabilize temperature, maintain composition state, sample, remove unnecessary gas and reconstruct hydrophobicity.

27. The cleaning device of claim 26, wherein the cleaning device is configured to withstand two or more semiconductor manufacturing processes or display manufacturing processes.

28. A method of cleaning, the method comprising:
performing a manufacturing process on a first semiconductor substrate;
performing the manufacturing process at least once on a cleaning device, the cleaning device including a first functional membrane configured to clean and including a second functional membrane, opposite the first functional membrane, configured to one of clean, control contamination, stabilize temperature, maintain composition state, sample, remove unnecessary gas and reconstruct hydrophobicity; and
performing the manufacturing process on a second semiconductor substrate.
